(19) United States
(12) Patent Application Publication
(10) Pub. No.: US 2025/0296110 A1
(43) Pub. Date: Sep. 25, 2025

(54) SYSTEM AND METHOD PROVIDING VISUAL EFFECT

(71) Applicant: INSTORE MEDIA KFT., Budapest (HU)

(72) Inventor: András GÓTZY, Budapest (HU)

(73) Assignee: INSTORE MEDIA KFT., Budapest (HU)

(21) Appl. No.: 19/104,645

(22) PCT Filed: Aug. 17, 2023
(86) PCT No.: PCT/HU2023/050051

§ 371 Date: Feb. 18, 2025

(30) Foreign Application Priority Data
Aug. 19, 2022 (HU) P2200344

(51) Int. Cl. B05B 17/08; A63J 21/00

(52) U.S. Cl. CPC B05B 17/085; A63J 21/00

(57) ABSTRACT

System and method for producing a visual effect, comprising a structure portion (1), at least one water-filled pool (2) arranged under the structure portion (1), at least one post (3) extending from the at least one pool (2), wherein the structure portion (1) is arranged at the end of the at least one post (3) lying further from the pool (2). The system further comprises a movable external shroud portion (4) that at least laterally envelopes the structure (1), a drive mechanism (5) that is arranged between the shroud portion (4) and the structure (1) and is adapted for moving the shroud portion (4) relative to the structure (1), and a high-pressure pump system (6) for generating water jets (8), said pump system comprising nozzles (7) arranged beside each other in the at least one pool (2) such that the water jets (8) form at least one continuous waterwall (9) that conceals the at least one post (3). During the method, the movable shroud portion (4) are moved by means of the drive mechanism (5), and simultaneously adjusting the height (H) of the waterjets (8) provided by the high-pressure pump system (6) such that the bottom edge (41) of the shroud portion (4) and the height (H) of the waterjets move in a mutually synchronised manner.

### TECHNICAL FIELD

The invention relates to a system and a method for producing a visual effect, and to a building provided with the system for producing a visual effect according to the invention.

### BACKGROUND ART

The prior art includes various technical solutions for fountains that, applying concealment by water jets, provide the visual impression of an object floating at the top of the water column. The majority of these solutions is implemented utilising support members made of transparent materials, applying water flowing around the support members, or water flowing downward along their surface.

The document with the publication number US 2003/015642 A1 discloses such a fountain arrangement that comprises a container having a top with an opening therein and a bottom for storing a liquid, for example water. An elongated, hollow support member is positioned within the interior of the container, extending from the opening in the top, the support member having a first end mounted at or near the bottom of the container, a second end terminating a predetermined distance above the opening in the top, and an exterior surface over which liquid flows. A pump positioned within the interior and operably connected to the first end of the support member pumps liquid in the interior into and through the hollow support member to flow out its second end and then along the exterior surface of the support member to return to the interior of the container.

According to another possible solution the water is pumped upwards from the bottom in some way, with the water curtain formed by the water jets concealing the support members.

The prior art technical solutions basically achieve the desired effect; however, they are limited both in the quality of the effect and in their usability.

The object of the system and method according to the present invention is to further improve the existing technical solutions in respect of both visual appearance and applicability.

The technical solution according to the present invention is based on the recognition that in order to convincingly imitate floating objects it is important not only to hide the support posts but also to give an impression to the outside observer that the floating object or structure is moving (wobbling, swaying) independently of the ground, as if the two bodies were completely independent of each other.

### BRIEF SUMMARY OF THE INVENTION

The objective of the invention is realised by providing a system that in its most general implementation comprises a structure portion, at least one water-filled pool arranged under the structure portion, at least one post extending from the at least one pool, wherein the structure portion is arranged at the end of the at least one post lying further from the pool. The system further comprises a movable external shroud portion that at least laterally envelopes the structure, a drive mechanism that is arranged between the shroud portion and the structure, and is adapted for moving the shroud portion relative to the structure, and a high-pressure pump system for generating water jets, said pump system comprising nozzles arranged beside each other in the at least one pool such that the water jets form at least one continuous waterwall that conceals the at least one post.

In a preferred embodiment of the system according to the invention, the height of the waterwall formed by the water jets can be adjusted utilising the high-pressure pump system.

In a further preferred embodiment of the system according to the invention, the system further comprises a control unit that is adapted for controlling the position of the shroud portion provided by the drive mechanism and the height of the water jets provided by the high-pressure pump system in a mutually synchronised manner, in real time.

In another preferred embodiment of the system according to the invention, the structure portion encompasses a freely usable interior space.

In a further exemplary embodiment of the system according to the invention, the movable shroud portion is formed from a plurality of separate shroud members.

In a further embodiment of the system according to the invention, the movable shroud portion is movable upward and downward relative to the structure.

In another embodiment of the system according to the invention, the movable shroud portion is movable in all three spatial directions relative to the structure.

In a further embodiment of the system according to the invention, the portion of the at least one post that is situated in the water-filled pool is provided with a reflective surface.

According to a still further embodiment of the system according to the invention, the entire surface of the water-filled pool is provided with a reflective surface.

A preferred exemplary implementation of the invention can be a building that comprises any one of the above-described systems.

The inventive objective can be fulfilled by providing a method comprising the steps of providing a structure arranged on at least one post extending from at least one pool, said structure being provided with a shroud portion arranged on a drive mechanism, further providing a high-pressure pump system comprising nozzles arranged beside each other in the at least one water-filled pool such that the water jets form at least one continuous waterwall that conceals the at least one post, and moving the movable shroud portion by means of the drive mechanism, and simultaneously adjusting the height of the water jets provided by the high-pressure pump system such that the bottom edge of the shroud portion and the height of the water jets move in a mutually synchronised manner.

A preferred way of carrying out the method according to the invention comprises moving the movable shroud portion upward and downward relative to the structure.

Another preferred way of carrying out the method according to the invention comprises moving the movable shroud portion in all three spatial directions.

### BRIEF DESCRIPTION OF THE DRAWINGS

Certain preferred embodiments of the technical solution according to the invention will be described with reference to the accompanying drawings, where

FIG. 1 shows an exemplary preferred embodiment of the system according to the invention in a perspective view,

FIG. 2 is a sectional view of the embodiment according to FIG. 1,

FIG. 3 shows a preferred configuration of an exemplary embodiment of the system according to the invention having a truncated pyramid geometric shape,

FIG. 4 shows another preferred implementation of an exemplary embodiment of the system according to the invention with a truncated pyramid geometric shape,

FIG. 5 shows a perspective view of another preferred embodiment of the system according to the invention,

FIG. 6 is a sectional view of the embodiment according to FIG. 5, and

FIG. 7 is a perspective view of a further possible embodiment of the system according to the invention.

### MODES FOR CARRYING OUT THE INVENTION

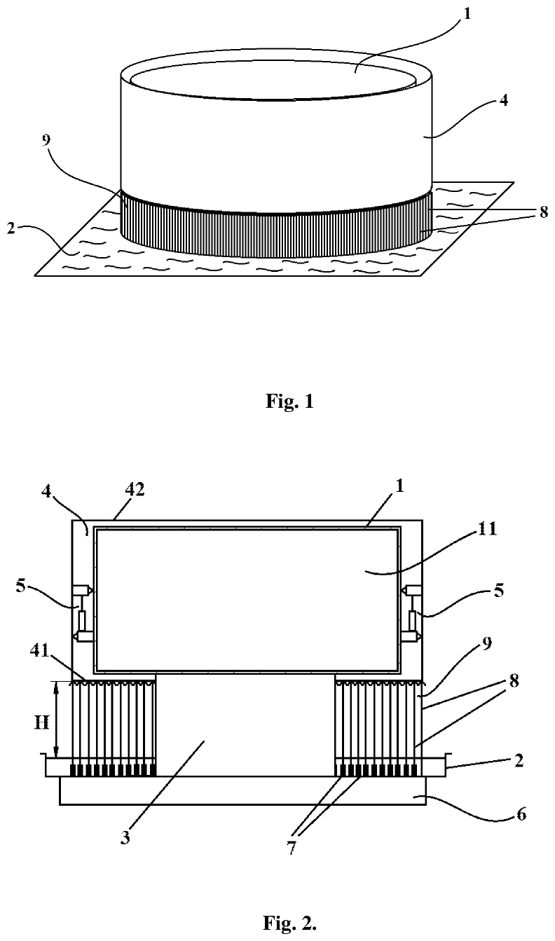

FIGS. 1 and 2 show a preferred embodiment of the system according to the invention. The system according to the exemplary embodiment comprises a cylindrical-shaped structure portion 1 that, alternatively to this embodiment, can also be configured to have other simple or complex geometric shape, such as a triangular-base, square-base, or hexagonal-base block shape, or a truncated pyramid shape. The system further comprises a pool 2 filled with water or with a liquid having properties identical to water, with a post 3 being disposed in the pool 2 such that the base of the post 3 is surrounded by the pool 2 from every direction, and the structure portion 1 is disposed at the top end of the post 3.

The structure portion 1 is provided with a movable external shroud portion 4 that preferably encompasses it laterally, and is connected to the structure portion 1 through a drive mechanism 5 arranged between the shroud portion 4 and the structure portion 1, with the shroud portion 4 being movable relative to the structure portion 1 by the drive mechanism 5. The distance between the wall of the shroud portion 4 and the wall of the structure portion 1 must be chosen such that the necessary constituent parts of the drive mechanism 5 can be accommodated therein.

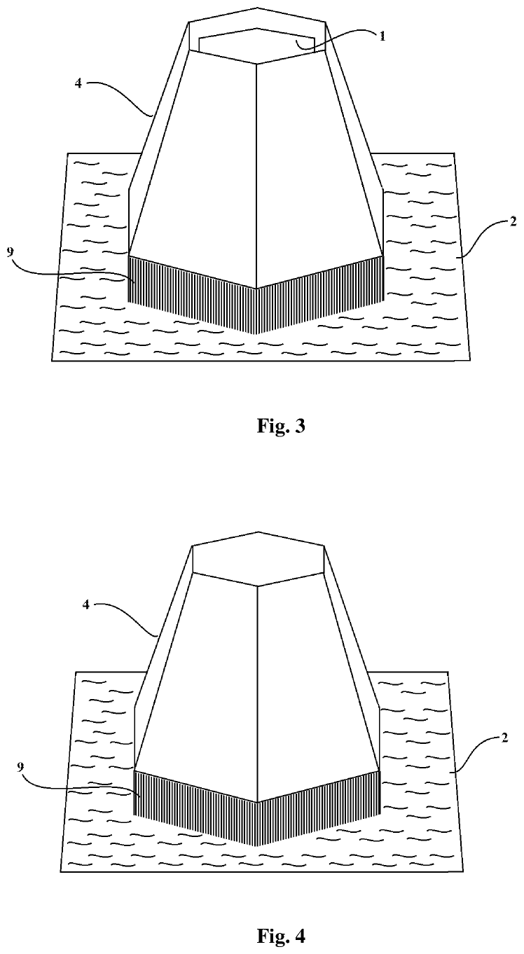

If—unlike in the embodiment illustrated in FIGS. 1 and 2—the walls of the structure portion 1 are not parallel to each other, the shroud portion 4 must be configured such that sufficient space is provided for accommodating the drive mechanism 5 between the walls of the shroud portion 4 and the structure portion 1, because in such a case the distance between the structure portion 1 and the shroud portion 4 varies depending on the position of the drive mechanism 5. Such embodiments are illustrated in FIG. 3 and in FIG. 4.

The movable shroud portion 4 is configured such that in the course of its movement the structure portion 1 is concealed from the outside observer in any position of the movement. Preferably, this can be brought about by ensuring that the shroud portion 4 overhangs both the upper and the bottom sides of the building portion at its upper edge 42 and also at its bottom edge 41.

Another feature of the embodiment illustrated in FIG. 4 is that the shroud portion 4 can be configured to envelope the structure portion 1 from above like a hood, as a result of which the structure portion is concealed also when viewed from above (and thus it cannot be seen in FIG. 4). In such a case it must be ensured that the upward and downward motion of the shroud portion 4 is also enabled in the upper portion.

Another elementary component of the system depicted in FIGS. 1-4 is a high-pressure pump system 6 adapted for providing water jets 8. The high-pressure pump system 6 includes a plurality of nozzles 7 arranged at the bottom of the pool 2, the nozzles being arranged side by side such that the water jets 8 form an essentially continuous waterwall 9. The waterwall 9 is arranged such that, for an outside observer, it obstructs from view the post 3, which is therefore not visible.

In order that the various components of the system can operate in a coordinated manner, the system further comprises a control unit that is adapted for controlling the position of the shroud portion 4 provided by the drive mechanism 5, and the height H of the water jets provided by the high-pressure pump system 6 in a mutually synchronised manner, in real time. The height H of the water jets 8 can even be adjusted individually, i.e., nozzle by nozzle, by the control unit applying the high-pressure pump system 6.

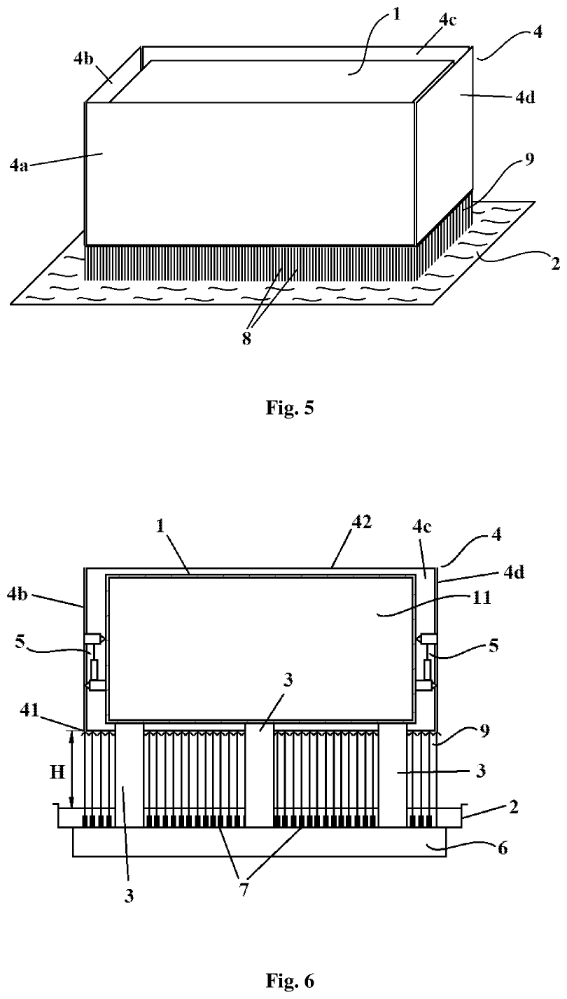

In FIGS. 5 and 6 there can be seen another preferred embodiment of the system according to the invention, wherein a structure portion 1 is disposed at the top end of more than one substantially vertical posts 3 preferably arranged in a water-filled pool 2. The posts can be of any number and shape that provide safe support of the structure portion 1.

In this exemplary embodiment the structure portion 1 is provided with a movable external shroud portion 4 that is formed of a plurality of shroud members 4a, 4b, 4c, 4d. The shroud portion can be moved in a member-by-member fashion, or even as a whole, preferably in an upward and downward direction perpendicular to the water surface of the pool 2, but such solutions can also be conceived wherein the shroud members can be moved with multiple degrees of freedom, i.e., in all spatial directions.

The drive mechanism 5 is disposed on the structure portion 1 between the structure portion 1 and the shroud members 4a, 4b, 4c, 4d of the shroud portion 4 in accordance with the degrees of freedom of the motion, allowing for the shroud members 4a, 4b, 4c, 4d to be moved.

The drive mechanism 5 is basically a mechanical solution known per se consisting of a plurality of components, for example an ensemble of hydraulic or pneumatic cylinders, or a solution with a rack and pinion or winch and wire arrangement driven by a (n electric) motor, but other technical solutions providing the required functionality can also be applied.

The shroud members 4a, 4b, 4c, 4d of the movable shroud portion 4 of the preferred embodiment depicted in FIGS. 5 and 6 are configured such that in the course of their movement the structure portion 1 is concealed from the outside observer in any position of the movement. Preferably, this can be brought about by ensuring that the shroud portion 4 overhangs both the upper and the bottom sides of the building portion at its upper edge 42 and also at its bottom edge 41, and that laterally they have a close fit or overlap each other.

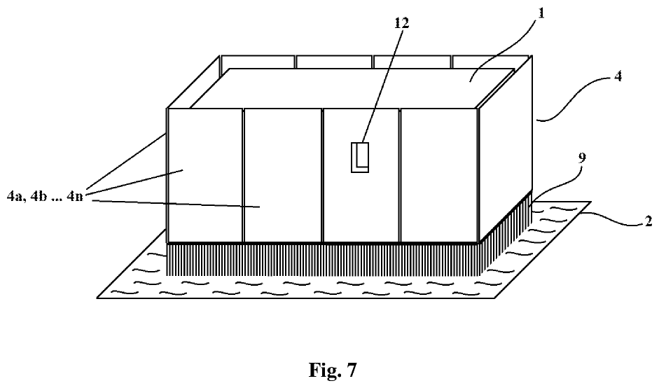

Other preferred configurations are possible wherein the shroud portion 4 is configured to comprise a plurality of separate shroud members 4a, 4b . . . 4n that—depending on the geometric shape of the structure portion 1—consist of differently sized elements or of identical elements surrounding the structure portion in an overlapping fashion. An example for such a configuration is depicted in FIG. 7.

The system comprises a high-pressure pump system 6 adapted for providing water jets 8 also in the case of the embodiments according to FIGS. 5-7, with the nozzles 7 thereof being arranged side by side in the pool 2 such that the water jets 8 form a substantially continuous waterwall 9 that is arranged to conceal the posts 3 from the outside observer.

For the purpose of operating its components, the system further comprises a control unit that is adapted for controlling the position of the shroud portion 4 provided by the drive mechanism 5, and the height H of the water jets provided by the high-pressure pump system 6 in a mutually synchronised manner, in real time. The height H of the water jets 8 can even be adjusted individually, i.e., nozzle by nozzle, by the control unit applying the high-pressure pump system 6.

In all exemplary embodiments (FIGS. 1-7) the structure portion 1 comprises a usable interior space 11, which can be for example a visitor space, a living space, or other functional room, or the structure portion 1 can be implemented in itself as a booth, a kiosk, or other building unit.

Various different openings 12, such as ventilation holes, window or door openings can be formed in the structure portion 1 and in the shroud portion 4 such that the interior space 11 can be utilised in accordance with its intended purpose (FIG. 7).

In another possible exemplary embodiment, for providing an improved visual effect, the portion of the posts 3 that is situated in the pool 2, or the entire underwater surface of the pool is provided with a mirroring or reflective surface, preferably a mirror.

The object of the invention is essentially implemented by a method that is carried out applying any one of the preferred embodiments depicted in the figures. The method comprises moving the shroud portion 4 by the drive mechanism 5, meanwhile providing water jets 8 by the high-pressure pump system 6. The height H of the water jets 8 is adjusted such that the bottom edge 41 of the shroud portion 4 and a height H of the water jets 8 move in a mutually coordinated fashion. The bottom edge 41 and the height H of the water jets 8 are preferably arranged with respect to each other to give the visual impression to the external observer that the shroud portion 4 of the system is kept at the given height by the waterwall 9 formed by the water jets 8. Preferably, this can be brought about by providing that the top end of the shroud portion 4 meets the top end of the water jets 8 or is at distance therefrom that is negligible with the naked eye. The simplest way of carrying out the exemplary method accurately is by applying a built-in control unit.

In such a manner, the technical solution according to the invention has a broader field of application compared to the prior art solutions, for instance for buildings and kiosks, and it can also visually imitate a motion of the building without moving the interior space and its occupants together with it. This improves the enjoyment value of the visual effect without exposing the users of the interior space to an uncomfortable “wobbling.”

### LIST OF REFERENCE NUMERALS

1—structure portion
2—pool
3—post
4—shroud portion
4a, 4b . . . 4n—shroud member
5—drive mechanism
6—high-pressure pump system
7—nozzle
8—water jet
9—waterwall
11—interior space
12—opening
41—bottom edge
42—upper edge

1. System for producing a visual effect, comprising:
a structure portion (1),
at least one water-filled pool (2) arranged under the structure portion (1),
at least one post (3) in said at least one water-filled pool and extending above the at least one water-filled pool (2),
wherein the structure portion (1) is arranged at the end of the at least one post (3) above the pool (2),
characterised in that the system further comprises
a movable external shroud portion (4) that at least laterally envelops the structure portion (1),
a drive mechanism(s) arranged between the external shroud portion (4) and the structure portion (1) and adapted for moving the external shroud portion (4) relative to the structure portion (1), and a high-pressure pump system (6) operably associated with the water-filled pool for generating water jets (8), said pump system comprising nozzles (7) arranged beside each other in said at least one water-filled pool (2) such that the water jets (8) form at least one continuous waterwall (9) that conceals the at least one post (3).

2. The system according to claim 1, characterised in that height (H) of the waterwall (9) formed by the water jets (8) is adjustable by the high-pressure pump system (6).

3. The system according to claim 1, characterised in that the system further comprises a control unit adapted for controlling the position of external shroud portion (4) and height (H) of the water jets provided by the high-pressure pump system (6) in a mutually synchronised manner, in real time.

4. The system according to claim 1, characterised in that the structure portion (1) encompasses a freely usable interior space (11).

5. The system according to claim 1, characterised in that the movable external shroud portion (4) is formed by a plurality of separate shroud members.

6. The system according to claim 1, characterised in that the movable external shroud portion (4) is movable upward and downward relative to the structure portion (1).

7. The system according to claim 1, characterised in that the movable external shroud portion (4) is movable in all spatial directions relative to the structure portion (1).

8. The system according to claim 1, characterised in that the surface of the at least one post (3) in contact with water in the water-filled pool (2) is a reflective surface.

9. The system according to claim 1, characterised in that entire surface of the water-filled pool (2) is reflective.

10. A building provided with a system according to claim 1.

11. A method for producing a visual effect, characterised by the following steps:
providing a structure portion (1) arranged on at least one post (3) extending from at least one water-filled pool (2), said structure (1) being provided with a shroud portion (4) arranged on a drive mechanism (5),
providing a high-pressure pump system (6) operably associated with the water-filled pool and comprising nozzles (7) arranged beside each other in the at least one water-filled pool (2) such that the water jets (8) form at least one continuous waterwall (9) that conceals the at least one post (3),
and moving the movable shroud portion (4) by means of the drive mechanism (5), and simultaneously adjusting height (H) of the water jets (8) provided by the high-pressure pump system (6) such that a bottom edge (41) of the shroud portion (4) and height (H) of the water jets move in a mutually synchronised manner.

12. The method according to claim 11, characterised by moving the movable shroud portion (4) upward and downward relative to the structure portion (1).

13. The method according claim 11, characterised by moving the movable shroud portion (4) in three spatial directions.
